(19) United States
(12) Patent Application Publication
(10) Pub. No.: US 2014/0037277 A1
(43) Pub. Date: Feb. 6, 2014

(54) HEAT MEDIUM HEATING DEVICE AND VEHICULAR AIR-CONDITIONING DEVICE INCLUDING THE SAME

(71) Applicants: Satoshi Kominami, Tokyo (JP); Naoto Kunieda, Aichi (JP)

(72) Inventors: Satoshi Kominami, Tokyo (JP); Naoto Kunieda, Aichi (JP)

(73) Assignee: Mitsubishi Heavy Industries, Ltd., Tokyo (JP)

(21) Appl. No.: 14/113,069

(22) PCT Filed: Aug. 7, 2012
(86) PCT No.: PCT/JP2012/070107

§ 371 Date: Oct. 21, 2013

(30) Foreign Application Priority Data
Sep. 9, 2011 (JP) 2011-197071

(51) Int. Cl. B60H 1/22

(52) U.S. Cl. CPC B60H 1/2225
USPC 392/482

(57) ABSTRACT

A heat medium heating device including flat heat exchange tubes and PTC heaters stacked in a plurality of layers, the heat medium heating device being capable of correctly and accurately detecting the temperature of a circulating heat medium; and a vehicular air-conditioning device including the same. In a heat medium heating device, flat heat exchange tubes each including an inlet header part and an outlet header part and PTC heaters are stacked in a plurality of layers, and are incorporated in a casing including a heat medium inlet path and a heat medium outlet path communicated with the inlet and outlet header parts. In the heat medium heating device thus configured, an inlet temperature sensor and an outlet temperature sensor that detect the temperature of a heat medium are provided around the inlet and outlet header parts of the lowermost flat heat exchange tube in the stacked structure.

### TECHNICAL FIELD

The present invention relates to a heat medium heating device that heats a heat medium using a PTC heater and a vehicular air-conditioning device including the heat medium heating device.

### BACKGROUND ART

In vehicular air-conditioning devices applied to electric automobiles, hybrid automobiles, and the like, it is known to use a positive temperature coefficient (PTC) heater for a heat medium heating device that heats a heat medium to be heated serving as a heat source for air heating. The PTC heater includes a positive temperature thermistor (hereinafter referred to as PTC element) as its heating element. With regard to such a heat medium heating device, PTL 1 discloses that: a housing includes an inlet and an outlet of a heat medium; a large number of partition walls for dividing the inside of the housing into a heating chamber and a circulation chamber of the heat medium are provided; a PTC heating element is inserted and placed in the heating chamber sectioned by the partition walls so as to be in contact with the partition walls; and the heat medium circulating in the circulation chamber is heated by the PTC heating element with the intermediation of the partition walls.

PTL 2 discloses a heat medium heating device having a stacking structure in which: a tabular PTC heater is configured by providing an electrode plate, an electrically insulating layer, and a heat transfer layer on each surface of a PTC element; a pair of heat medium circulation boxes that each include an inlet and an outlet of a heat medium and are communicated with each other are respectively stacked on both surfaces of the PTC heater; and a substrate housing box and a cover for housing a control substrate are further provided on the outer side of the resultant structure.

Unfortunately, in the configuration according to PTL 1, it is difficult to closely insert and place the PTC heating element to between the partition walls serving as heat transfer surfaces, and the thermal contact resistance between the partition walls and the PTC heating element increases, resulting in a decrease in heat transfer efficiency. Further, in the configuration according to PTL 2, close contact between the PTC heater and the heat medium circulation boxes can be enhanced, and the thermal contact resistance can be reduced. Meanwhile, because it is difficult to arrange PTC heaters in a plurality of layers, the planar area increases, and the heat medium circulation boxes and the special substrate housing box are necessary, which put a limitation on a decrease in size, weight, and cost.

A heat medium heating device that has been developed in view of the above has a configuration in which: heat exchange tubes having a flat structure are used; a heat exchange element is formed by stacking the flat heat exchange tubes and PTC heaters in a plurality of layers; and the heat exchange element is incorporated in a casing. Further, with regard to a stacking-type heat exchange element (cooler), PTL 3 discloses that: inlet and outlet pipes for a refrigerant are connected to a heat exchange tube arranged at one end in the stacking direction of heat exchange tubes stacked in a plurality of layers; and a temperature detector is placed in a heat exchange tube arranged at another end therein, whereby the temperature of the refrigerant can be accurately detected while disturbance is eliminated.

### CITATION LIST

### Patent Literature

### {PTL 1}

Japanese Unexamined Patent Application, Publication No. 2008-7106

### {PTL 2}

Japanese Unexamined Patent Application, Publication No. 2008-56044

### {PTL 3}

The Publication of Japanese Patent No. 4725536

### SUMMARY OF INVENTION

### Technical Problem

In the configuration as described above in which the temperature sensor is provided to the heat exchange tube arranged on the opposite side to the heat exchange tube to which the refrigerant inlet/outlet pipes are connected, the temperature sensor can be easily attached, and, moreover, the temperature of the refrigerant can be detected with the intermediation of the tube wall. Accordingly, the temperature detection accuracy can be enhanced. However in the configuration in which PTC heaters are stacked in a plurality of layers and are turned on/off for performance control, even if the temperature of the heat exchange tube arranged on the opposite side to the heat exchange tube to which the refrigerant inlet/outlet pipes are connected can be accurately detected, the representative temperature of a heat medium circulating in a stacking-type heat exchange element cannot be correctly detected.

The present invention, which has been made in view of the above-mentioned circumstances, has an object to provide: a heat medium heating device including flat heat exchange tubes and PTC heaters stacked in a plurality of layers, the heat medium heating device being capable of correctly and accurately detecting the temperature of a circulating heat medium, irrespective of turning on/off of the PTC heaters; and a vehicular air-conditioning device including the heat medium heating device.

### Solution to Problem

In order to solve the above-mentioned problems, a heat medium heating device and a vehicular air-conditioning device including the same according to the present invention adopt the following solutions.

That is, a heat medium heating device according to a first aspect of the present invention includes: a plurality of flat heat exchange tubes each including: an inlet header part and an outlet header part that are provided next to each other at one end of the flat heat exchange tube; and a U-turn part provided at another end thereof, the inlet header part causing a heat medium to flow into the flat heat exchange tube, the U-turn part causing the heat medium to make a U-turn, and the outlet header part causing the heat medium to flow out of the flat heat exchange tube; PTC heaters that are respectively incorporated to between the plurality of stacked flat heat exchange tubes; and a casing having: a bottom surface on which a heat medium inlet path and a heat medium outlet path are provided, the heat medium inlet path and the heat medium outlet path being respectively communicated with the inlet header parts and the outlet header parts of the flat heat exchange tubes; and an inner bottom surface on which the flat heat exchange tubes and the PTC heaters are stacked and incorporated in a plurality of layers. An inlet temperature sensor and an outlet temperature sensor that detect a temperature of the heat medium are provided around the inlet header part and the outlet header part of the lowermost one of the flat heat exchange tubes stacked in the plurality of layers.

According to the first aspect, the flat heat exchange tubes each including the inlet header part and the outlet header part and the PTC heaters are stacked in the plurality of layers, and the stacked structure is incorporated in the casing including the heat medium inlet path and the heat medium outlet path respectively communicated with the inlet header parts and the outlet header parts. In the heat medium heating device thus configured, the inlet temperature sensor and the outlet temperature sensor that detect the temperature of the heat medium are provided around the inlet header part and the outlet header part of the lowermost one of the flat heat exchange tubes stacked in the plurality of layers. In this configuration, the heat medium passes through the heat medium inlet path, and flows into the flat heat exchange tubes from the respective inlet header parts. The branched heat mediums are heated by the PTC heaters while circulating in the plurality of flat heat exchange tubes stacked in the plurality of layers, pass through the outlet header parts, and flow out from the heat medium outlet path. The inlet temperature and the outlet temperature of such a heat medium can be detected at the positions of the inlet header part and the outlet header part of the lowermost flat heat exchange tube, at which the most representative values of the inlet temperature and the outlet temperature can be obtained. That is, because the inlet temperature of the heat medium is detected in the inlet header part of the lowermost flat heat exchange tube, the inlet temperature can be detected in its lowest state before heating. Because the outlet temperature of the heat medium is detected in the outlet header part of the lowermost flat heat exchange tube, the outlet temperature can be detected in its highest state after heating. Accordingly, the temperature of the heat medium can be accurately and correctly detected, and the controllability of the heat medium heating device can be enhanced by controlling the heat medium heating device and the like on the basis of the temperature thus detected.

Moreover, in the heat medium heating device according to the first aspect, the inlet temperature sensor and the outlet temperature sensor may be provided next to each other in a space part between the inlet header part and the outlet header part, at the one end of the flat heat exchange tube at which the inlet header part and the outlet header part are provided next to each other.

According to the first aspect, the inlet temperature sensor and the outlet temperature sensor are provided next to each other in the space part between the inlet header part and the outlet header part, at the one end of the flat heat exchange tube at which the inlet header part and the outlet header part are provided next to each other. Hence, the two inlet temperature sensor and outlet temperature sensor can be adjacently placed between the inlet header part and the outlet header part. Accordingly, the inlet temperature sensor and the outlet temperature sensor can be placed more easily, and lead wires thereof can be connected more easily, so that assembling properties of the two temperature sensors can be improved.

Moreover, in the heat medium heating device according to the first aspect, the space part may be provided with a heat conduction insulating slit between a placement part for the inlet temperature sensor and a placement part for the outlet temperature sensor.

According to the first aspect, the heat conduction insulating slit is provided between the placement part for the inlet temperature sensor and the placement part for the outlet temperature sensor in the space part. Hence, heat conduction between the placement part for the inlet temperature sensor and the placement part for the outlet temperature sensor can be insulated by the slit. Accordingly, even if the two temperature sensors are adjacently provided next to each other, temperature interference therebetween can be prevented, and the temperature of the heat medium can be accurately and correctly detected by each of the temperature sensors.

Moreover, a vehicular air-conditioning device according to a second aspect of the present invention includes: a heat radiator disposed in an airflow path; and a heat medium heating device that heats a heat medium, the heated heat medium being circulatable in the heat radiator. The heat medium heating device is the heat medium heating device having any of the above-mentioned features.

According to the second aspect, the heat medium to be circulated in the heat radiator disposed in the airflow path can be heated for circulation by the heat medium heating device having improved controllability. Hence, the temperature controllability of the vehicular air-conditioning device, particularly, the temperature controllability thereof during air heating can be improved, thus achieving comfortable air conditioning.

### Advantageous Effects of Invention

According to the heat medium heating device of the present invention, the heat medium passes through the heat medium inlet path, and flows into the flat heat exchange tubes from the respective inlet header parts. The branched heat mediums are heated by the PTC heaters while circulating in the plurality of flat heat exchange tubes stacked in the plurality of layers, pass through the outlet header parts, and flow out from the heat medium outlet path. The inlet temperature and the outlet temperature of such a heat medium can be detected at the positions of the inlet header part and the outlet header part of the lowermost flat heat exchange tube, at which the most representative values of the inlet temperature and the outlet temperature can be obtained. That is, because the inlet temperature of the heat medium is detected in the inlet header part of the lowermost flat heat exchange tube, the inlet temperature can be detected in its lowest state before heating. Because the outlet temperature of the heat medium is detected in the outlet header part of the lowermost flat heat exchange tube, the outlet temperature can be detected in its highest state after heating. Accordingly, the temperature of the heat medium can be accurately and correctly detected, and the controllability of the heat medium heating device can be enhanced by controlling the heat medium heating device and the like on the basis of the temperature thus detected.

Further, according to the vehicular air-conditioning device of the present invention, the heat medium to be circulated in the heat radiator disposed in the airflow path can be heated for circulation by the heat medium heating device having improved controllability. Hence, the temperature controllability of the vehicular air-conditioning device, particularly, the temperature controllability thereof during air heating can be improved, thus achieving comfortable air conditioning.

### BRIEF DESCRIPTION OF DRAWINGS

FIG. 1 is a schematic configuration diagram of a vehicular air-conditioning device including a heat medium heating device according to a first embodiment of the present invention.

FIG. 2 is an exploded perspective view for describing procedures for assembling the heat medium heating device illustrated in FIG. 1.

FIG. 3 is a view corresponding to a longitudinal section taken along a heat medium inlet path (or a heat medium outlet path) of the heat medium heating device illustrated in FIG. 2.

FIG. 4 is an exploded perspective view illustrating a state where flat heat exchange tubes of the heat medium heating device illustrated in FIG. 2 are stacked and incorporated.

FIG. 5 is a plan view of a state where a temperature sensor is incorporated in a lowermost flat heat exchange tube illustrated in FIG. 4.

FIG. 6 is a plan view of a state before the temperature sensor of the lowermost flat heat exchange tube illustrated in FIG. 5 is incorporated.

### DESCRIPTION OF EMBODIMENTS

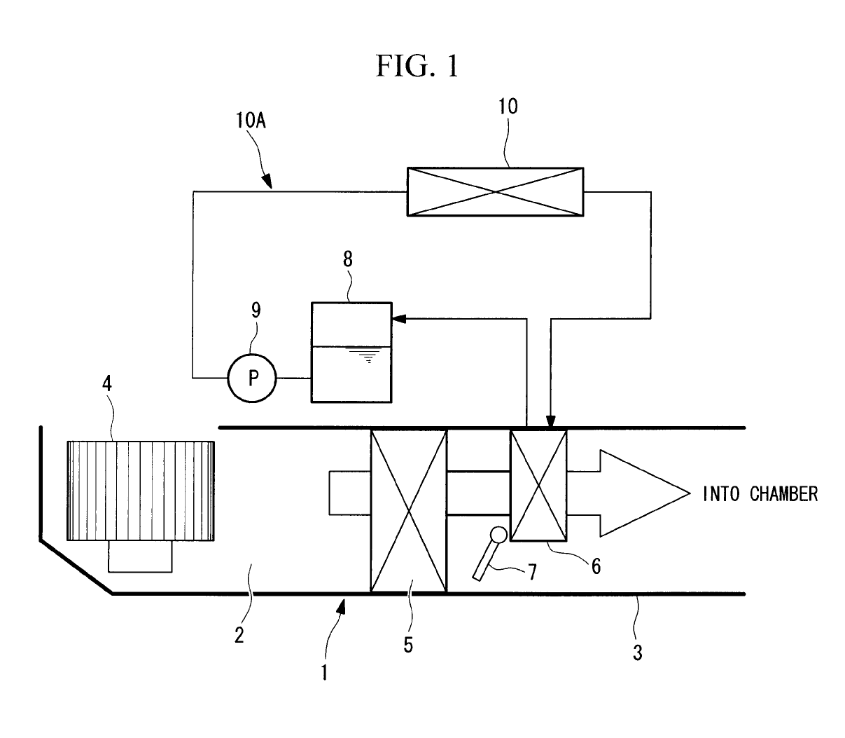

Hereinafter, an embodiment of the present invention is described with reference to FIG. 1 to FIG. 6.

FIG. 1 is a schematic configuration diagram of a vehicular air-conditioning device including a heat medium heating device according to the embodiment of the present invention.

A vehicular air-conditioning device 1 includes a casing 3 that forms an air circulation path 2 for taking therein external air or air in a chamber, regulating the temperature thereof, and then guiding the air into the chamber.

A blower 4, a cooler 5, a heat radiator 6, and an air mix damper 7 are placed in the stated order from the upstream side to the downstream side of the air circulation path 2 inside of the casing 3. The blower 4 suctions external air or air in the chamber, increases the pressure thereof, and sends under pressure the resultant air to the downstream side. The cooler 5 cools the air sent under pressure by the blower 4. The heat radiator 6 heats the air that is cooled while passing through the cooler 5. The air mix damper 7 adjusts the flow ratio of the amount of air passing through the heat radiator 6 to the amount of air bypassing the heat radiator 6, and mixes the two flows of air downstream of the heat radiator 6, to thereby regulate the temperature of air.

The downstream side of the casing 3 is connected to a plurality of blow-out ports that blow out, into the chamber, the temperature-regulated air through a blow-out mode switching damper and a duct, which are not illustrated.

The cooler 5 constitutes a refrigerant circuit together with a compressor, a condenser, and an expansion valve, which are not illustrated, and the cooler 5 evaporates a refrigerant adiabatically expanded by the expansion valve, to thereby cool air passing therethrough. Further, the heat radiator 6 constitutes a heat medium circulation circuit 10A together with a tank 8, a pump 9, and a heat medium heating device 10. A heat medium (for example, antifreeze liquid or warm water) that is heated to a high temperature by the heat medium heating device 10 is circulated in the heat medium circulation circuit 10A by the pump 9, whereby the heat radiator 6 warms air passing therethrough.

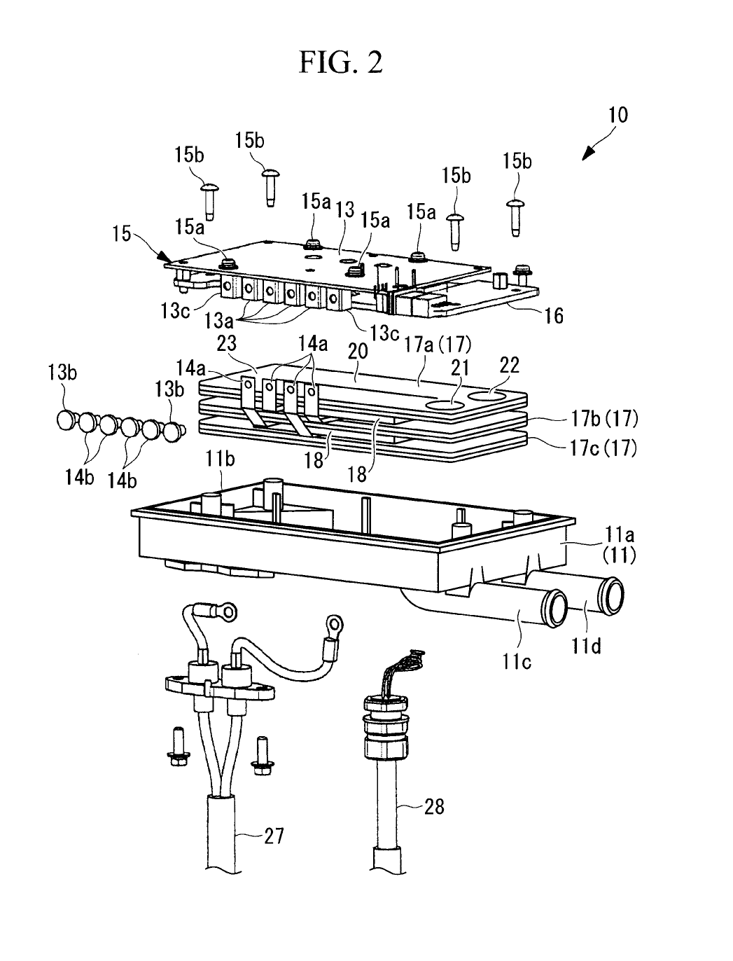

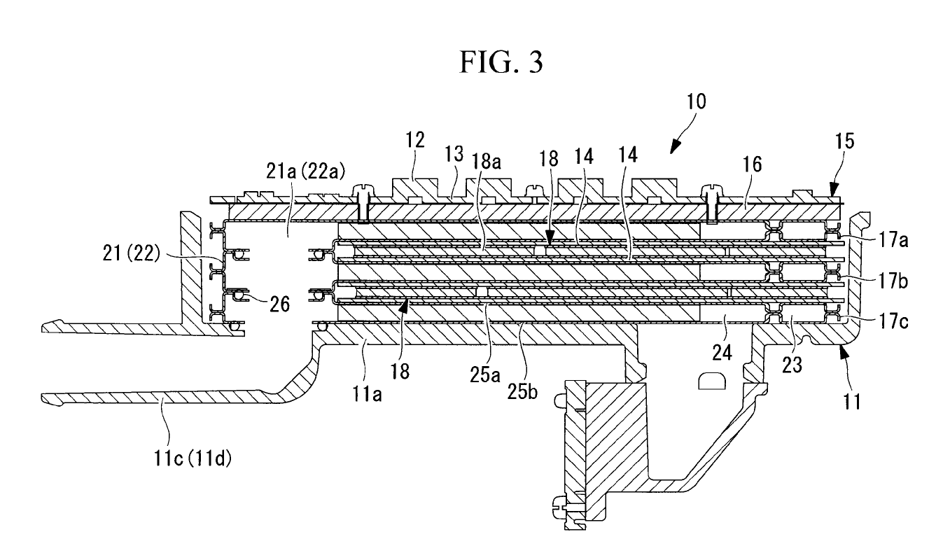

FIG. 2 is an exploded perspective view for describing procedures for assembling the heat medium heating device 10 illustrated in FIG. 1, and FIG. 3 is a view corresponding to a longitudinal section taken along a heat medium inlet path (or a heat medium outlet path) of the heat medium heating device 10.

As illustrated in FIG. 2, the heat medium heating device 10 includes: a control substrate 13; a plurality of electrode plates 14 (see FIG. 3); a plurality of semiconductor switching elements 12 (see FIG. 3) such as IGBTs disposed on the control substrate 13; a heat exchange holding member 16; a plurality of (for example, three) flat heat exchange tubes 17; a plurality of PTC elements 18a (see FIG. 3); and a casing 11 that houses therein the control substrate 13, the electrode plates 14, the semiconductor switching elements 12, the flat heat exchange tubes 17, the heat exchange holding member 16, the PTC elements 18a, and the like.

Note that each PTC heater 18 is configured by the electrode plates 14, the PTC element 18a, electrically insulating members (not illustrated), and the like.

The casing 11 is divided in two, that is, an upper half part and a lower half part, and thus includes an upper case (not illustrated) constituting the upper half part and a lower case 11a constituting the lower half part. The upper case is put in an opening part 11b of the lower case 11a from above the lower case 11a, whereby a space for housing the control substrate 13, the semiconductor switching elements 12, the electrode plates 14, the heat exchange holding member 16, the plurality of flat heat exchange tubes 17, the plurality of PTC heaters 18, and the like is formed inside of the upper case and the lower case 11a.

A heat medium inlet path 11c and a heat medium outlet path 11d are integrally formed on the bottom surface of the lower case 11a. The heat medium inlet path 11c serves to guide the heat medium to be introduced into the three stacked flat heat exchange tubes 17, and the heat medium outlet path 11d serves to guide the heat medium that has circulated in the flat heat exchange tubes 17 to the outside. The heat medium inlet path 11c and the heat medium outlet path 11d are extended from the bottom surface of the lower case 11a in parallel to each other in the same horizontal direction, and protrude laterally from one end of the lower case 11a. Note that the upper case and the lower case 11a are molded using a resin material (for example, PPS) having a coefficient of linear expansion close to that of an aluminum alloy material forming the flat heat exchange tubes 17 housed in the space inside of the upper case and the lower case 11a. Because the casing 11 is made of the resin material in this way, a reduction in weight can be achieved.

Further, power supply harness holes (not illustrated) and a LV harness hole (not illustrated) are opened in the lower surface of the lower case 11a, and respectively allow leading end parts of the power supply harness 27 and the LV harness 28 to pass therethrough. The power supply harness 27 supplies electric power to the PTC heaters 18 through the control substrate 13 and the semiconductor switching elements 12. The leading end part of the power supply harness 27 is bifurcated, and the two ends thereof can be respectively fixed to two power supply harness terminal mounts 13c provided to the control substrate 13, using power supply harness connection screws 13b. Further, the LV harness 28 transmits a control signal to the control substrate 13, and the leading end part thereof can be connector-connected to the control substrate 13.

The semiconductor switching elements 12 and the control substrate 13 constitute a control system that controls current application to the plurality of PTC heaters 18 on the basis of a command from an engine control unit (ECU), and whether or not to apply current to the plurality of PTC heaters 18 can be switched through the plurality of semiconductor switching elements 12 such as the IGBTs. Then, the plurality of flat heat exchange tubes 17 are stacked so as to sandwich each of the plurality of PTC heaters 18.

The flat heat exchange tubes 17 are made of an aluminum alloy material, and, as illustrated in FIG. 2 to FIG. 4, lower, middle, and upper flat heat exchange tubes 17c, 17b, and 17a (three flat heat exchange tubes 17) are stacked in the stated order in parallel to each other. As illustrated in FIG. 2 to FIG. 4, the flat heat exchange tubes 17 each include: an inlet header part 21 and an outlet header part 22 that are provided next to each other at one end of a flat tube part 20; and a U-turn part 23 that is formed at another end of the flat tube part 20 and causes a flow of the heat medium to make a U-turn. A U-turn flow path 24 is formed in the flat tube part 20 so as to run from the inlet header part 21 to the outlet header part 22 through the U-turn part 23.

Each flat heat exchange tube 17 is formed by putting a pair of thin molded plate members 25a and 25b made of an aluminum alloy material on top of each other and brazing the molded plate members 25a and 25b to each other. The flat tube part 20, the inlet header part 21, and the outlet header part 22 are integrally molded in the pair of molded plate members 25a and 25b. The size in the thickness direction of the inlet header part 21 and the outlet header part 22 is set to be larger than the size in the thickness direction of the flat tube part 20 forming the U-turn flow path 24. When the three flat heat exchange tubes 17a, 17b, and 17c are stacked, a gap having a predetermined size is formed between the adjacent flat tube parts 20. Each PTC heater 18 that is sandwiched by the electrode plates 14, the electrically insulating members (not illustrated), and the like from above and below the PTC heater 18 is interposed in this gap, whereby the three flat heat exchange tubes 17 and the two PTC heaters 18 are stacked in a plurality of layers.

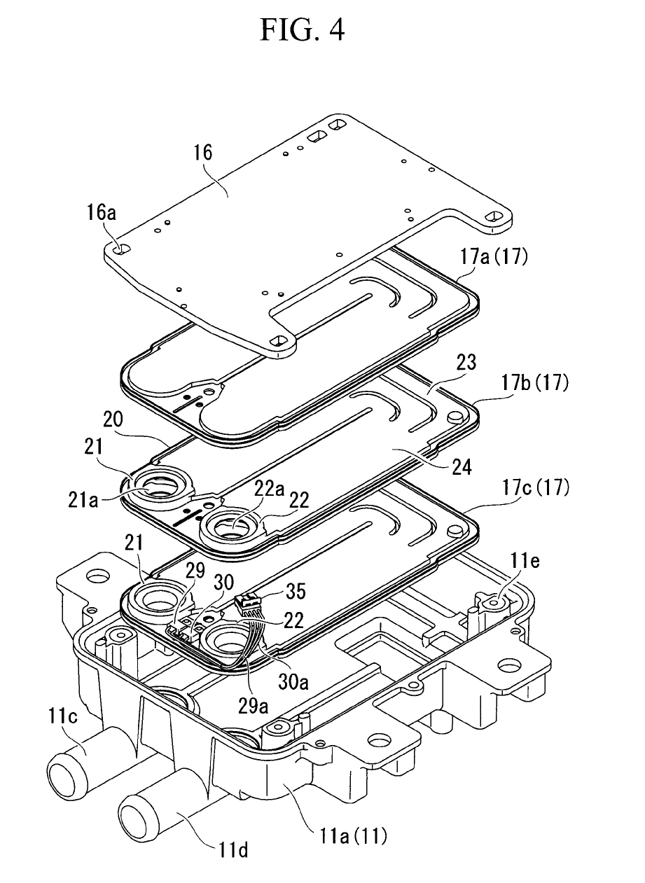

Further, when the flat heat exchange tubes 17 are stacked, as illustrated in FIGS. 3 and 4, the respective inlet header parts 21 thereof are in close contact with each other, and the respective outlet header parts 22 thereof are in close contact with each other. Consequently, communication holes 21a provided to the inlet header parts 21 are communicated with each other, and communication holes 22a provided to the outlet header parts 22 are communicated with each other. At this time, the communication holes 21a and 22a are each sealed by a seal member 26 such as an O-ring, a gasket, or a liquid gasket (in the present embodiment, the O-ring is used) disposed therearound.

Between the respective inlet header parts 21 (outlet header parts 22) of the flat heat exchange tube 17a and the flat heat exchange tube 17b, the seal member (O-ring) 26 is placed around the communication hole 21a (22a) on the side of the molded plate member 25b constituting the flat heat exchange tube 17b. Between the respective inlet header parts 21 (outlet header parts 22) of the flat heat exchange tube 17b and the flat heat exchange tube 17c, the seal member (O-ring) 26 is placed around the communication hole 21a (22a) on the side of the molded plate member 25b constituting the flat heat exchange tube 17c. Between the inlet header part 21 (outlet header part 22) of the flat heat exchange tube 17c and the inner bottom surface of the lower case 11a, the seal member (O-ring) 26 is placed in a disposition portion for the seal member 26 formed on the inner bottom surface of the lower case 11a.

Moreover, an inlet temperature sensor 29 and an outlet temperature sensor 30 are provided to the lowermost flat heat exchange tube 17c of the three stacked flat heat exchange tubes 17. The inlet temperature sensor 29 detects the temperature of the heat medium that has flown into the heat medium heating device 10 from the heat medium inlet path 11c and has not yet been branched into the three flat heat exchange tubes 17a, 17b, and 17c from the respective inlet header parts 21. The outlet temperature sensor 30 detects the temperature of the branched heat mediums that have circulated in the three flat heat exchange tubes 17a, 17b, and 17c, have been heated by the PTC heaters 18, have joined together in the outlet header parts 22, and then flow out of the heat medium heating device 10.

As illustrated in FIG. 4 to FIG. 6, the inlet temperature sensor 29 and the outlet temperature sensor 30 are adjacently provided next to each other in a space part 31. The space part 31 is formed around and between the inlet header part 21 and the outlet header part 22 that are provided next to each other at one end of the lowermost flat heat exchange tube 17c. As illustrated in FIG. 6, the space part 31 is sectioned by a heat conduction insulating slit 32 provided between an inlet-side sensor placement part 31a and an outlet-side sensor placement part 31b. The inlet temperature sensor 29 is placed in the inlet-side sensor placement part 31a on the inlet header part 21 side, and the outlet temperature sensor 30 is placed in the outlet-side sensor placement part 31b on the outlet header part 22 side.

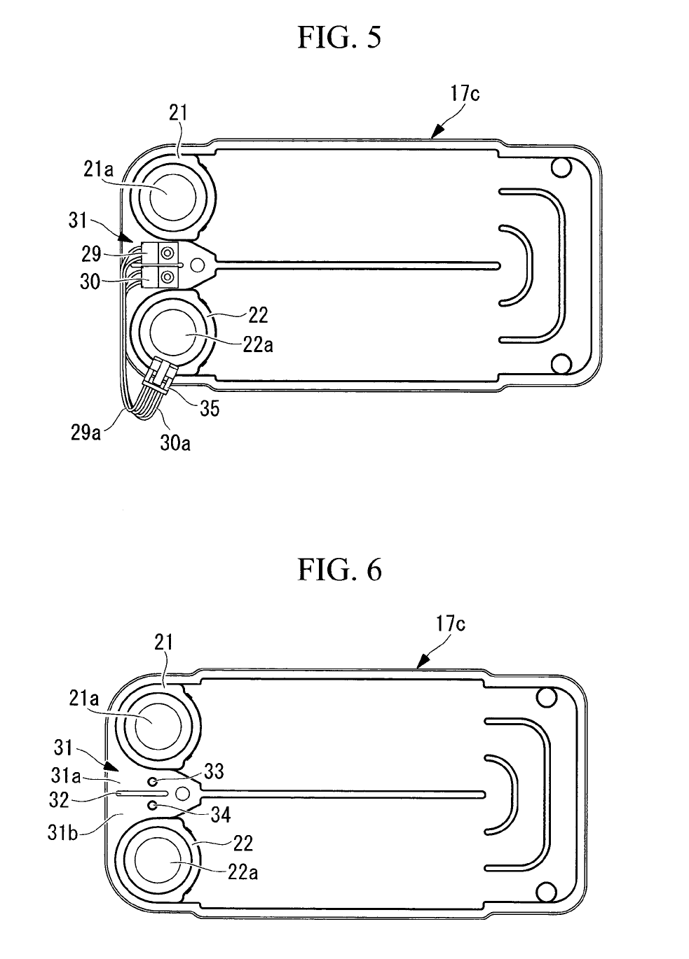

The inlet-side sensor placement part 31a and the outlet-side sensor placement part 31b are respectively provided with sensor attachment holes 33 and 34. As illustrated in FIGS. 4 and 5, the inlet temperature sensor 29 and the outlet temperature sensor 30 are respectively fixed by bolts and nuts to the inlet-side sensor placement part 31a and the outlet-side sensor placement part 31b through the sensor attachment holes 33 and 34. Note that two lead wires 29a and 30a are drawn from the inlet temperature sensor 29 and the outlet temperature sensor 30, and are connected to the control substrate 13 through a connector 35.

Further, the plurality of PTC heaters 18 are respectively incorporated in the following manner into the gaps between the flat tube parts 20 of the three flat heat exchange tubes 17 with the intermediation of the electrode plates 14 and the electrically insulating sheets (not illustrated).

As illustrated in FIG. 3, the electrode plates 14 serve to supply electric power to the PTC element 18a, and are plate members that are rectangular in plan view and made of an aluminum alloy. The electrode plates 14 sandwich the PTC element 18a. Specifically, one electrode plate 14 is stacked in contact with the upper surface of the PTC element 18a, and another one electrode plate 14 is stacked in contact with the lower surface of the PTC element 18a. These two electrode plates 14 sandwich the upper surface and the lower surface of the PTC element 18a from above and below the PTC element 18a.

Then, the electrode plate 14 arranged on the upper surface side of the PTC element 18a is arranged such that the upper surface thereof is in contact with the lower surface of one of the flat heat exchange tubes 17 with the intermediation of the electrically insulating member. The electrode plate 14 arranged on the lower surface side of the PTC element 18a is arranged such that the lower surface thereof is in contact with the upper surface of another one of the flat heat exchange tubes 17 with the intermediation of the electrically insulating member. In the present embodiment, two electrode plates 14 are arranged between the lower flat heat exchange tube 17c and the middle flat heat exchange tube 17b, and two electrode plates 14 are arranged between the middle flat heat exchange tube 17b and the upper flat heat exchange tube 17a. That is, the total number of the electrode plates 14 is four. The PTC heaters 18 sandwiched by the electrode plates 14 are respectively stacked and disposed between the flat tube parts 20 of the three flat heat exchange tubes 17.

The four electrode plates 14 each have substantially the same shape as that of the flat tube part 20 of each flat heat exchange tube 17. Each electrode plate 14 is provided with terminals 14a (see FIG. 2) on its longer side. The terminals 14a are arranged along the longer side direction of the electrode plates 14 so as not to overlap with each other when the electrode plates 14 are stacked. That is, the positions of the terminals 14a provided to the electrode plates 14 are slightly different from each other in the longer side direction, and the terminals 14a are arranged in a line when the electrode plates 14 are stacked. Each terminal 14a is provided so as to protrude upward, and is connected to a terminal mount 13a provided to the control substrate 13, using a terminal connection screw 14b.

A substrate sub-assembly 15 is integrated by sandwiching an electrically insulating sheet and the like by the control substrate 13 and the heat exchange holding member 16 and tightening the resultant structure using, for example, four substrate sub-assembly connection screws 15a. Note that the semiconductor switching elements 12 such as the IGBTs provided on the control substrate 13 are heat generating components, and heat generated thereby passes through heat transfer parts that are provided to the control substrate 13 correspondingly to placement parts for the semiconductor switching elements 12, and is released to the heat exchange holding member 16 side, to be thereby cooled by the heat medium circulating in the flat heat exchange tubes 17.

Further, the control substrate 13 constituting the substrate sub-assembly 15 is provided with four terminal mounts 13a that are arranged in a line on one side thereof correspondingly to the four terminals 14a that are arranged in a line on the electrode plates 14. Further, the two power supply harness terminal mounts 13c respectively connected to the bifurcated leading end parts of the power supply harness 27 are provided so as to be arranged in a line on both end sides of the four terminal mounts 13a. The terminal mounts 13a and the power supply harness terminal mounts 13c are provided so as to protrude downward (or upward) from the control substrate 13. Further, the terminal mounts 13a and the power supply harness terminal mounts 13c are disposed in a line along the longer sides of the stacked flat heat exchange tubes 17a, 17b, and 17c.

Moreover, the terminal mounts 13a and the power supply harness terminal mounts 13c provided to the control substrate 13 are located at a position slightly above the opening part 11b of the lower case 11a. With this configuration, the terminals 14a of the electrode plates 14 and the leading end parts of the power supply harness 27 respectively connected to the terminal mounts 13a and the power supply harness terminal mounts 13c are more easily fixed.

Meanwhile, the heat exchange holding member 16 constituting the substrate sub-assembly 15 is a plate member that is flat in plan view and made of an aluminum alloy. As described above, the control substrate 13 is arranged on the upper surface of the heat exchange holding member 16. As illustrated in FIG. 4, the heat exchange holding member 16 has a size large enough to cover the flat tube part 20, the inlet header part 21, and the outlet header part 22 of each flat heat exchange tube 17. Through-holes 16a are respectively provided in four corner parts of the heat exchange holding member 16. The through-holes 16a respectively allow substrate sub-assembly fixing screws 15b to pass therethrough. The substrate sub-assembly fixing screws 15b serve to fix the heat exchange holding member 16 to boss parts 11e of the lower case 11a.

The substrate sub-assembly 15 is put on the upper surface of the stacked upper flat heat exchange tube 17a, and is disposed such that the lower surface of the heat exchange holding member 16 is in contact with the upper surfaces of the flat tube part 20, the inlet header part 21, and the outlet header part 22 of the upper flat heat exchange tube 17a. In the configuration of the substrate sub-assembly 15, if the heat exchange holding member 16 is screwed to the lower case 11a as described above, between the lower surface of the heat exchange holding member 16 and the inner bottom surface of the lower case 11a, the respective flat tube parts 20 of the stacked flat heat exchange tubes 17a, 17b, and 17c and the two PTC heaters 18 sandwiched therebetween can be pressed and brought into close contact with each other, and the seal member (in the present embodiment, the O-ring) 26 that is disposed around each of the communication holes 21a and 22a provided to the inlet header part 21 and the outlet header part 22 of each flat heat exchange tube 17 can be brought into close contact for tightening and fixing.

With this configuration, the heat medium that has flown in from the heat medium inlet path 11c circulates in the following flow path. The heat medium is introduced into the flat tube part 20 from the inlet header part 21 of each flat heat exchange tube 17, is heated by the PTC heater 18 to have a higher temperature while circulating in the U-turn flow path 24 of the flat tube part 20, reaches the outlet header part 22, and passes through the outlet header part 22 and then the heat medium outlet path 11d to flow to the outside. The heat medium that has flown out of the heat medium heating device 10 is supplied to the heat radiator 6 through the heat medium circulation circuit 10A (see FIG. 1).

Further, the heat exchange holding member 16 constituting the substrate sub-assembly 15 is made of an aluminum alloy material having excellent heat conductivity, and the lower surface thereof is in contact with the upper surface of the uppermost flat heat exchange tube 17a. With this configuration, the heat medium flowing in each flat heat exchange tube 17 as described above serves as a cooling heat source for the heat exchange holding member 16, and the heat exchange holding member 16 also functions as a heat sink for cooling the semiconductor switching elements 12 such as the IGBTs placed on the control substrate 13.

In the heat medium heating device 10, the three flat heat exchange tubes 17a, 17b, and 17c and the upper and lower two PTC heaters 18 can be incorporated into the lower case 11a in the following manner. First, the seal member 26 is arranged around each of opening parts of the heat medium inlet path 11c and the heat medium outlet path 11d opened in the inner bottom surface of the lower case 11a, and the lowermost flat heat exchange tube 17c is put thereon. At this time, if the inlet temperature sensor 29 and the outlet temperature sensor 30 are attached in advance to the lowermost flat heat exchange tube 17c, the inlet temperature sensor 29 and the outlet temperature sensor 30 can be incorporated at the same time.

The PTC heater 18 and the seal members 26 are arranged on the upper surface of the lowermost flat heat exchange tube 17c. The middle flat heat exchange tube 17b is put thereon. The PTC heater 18 and the seal members 26 are further arranged on the upper surface of the middle flat heat exchange tube 17b. The upper flat heat exchange tube 17a is put thereon. As a result, the three flat heat exchange tubes 17a, 17b, and 17c and the upper and lower two PTC heaters 18 can be stacked and incorporated in a plurality of layers with the seal member 26 being disposed around each of the communication holes 21a and 22a of the inlet header parts 21 and the outlet header parts 22.

In this way, the three flat heat exchange tubes 17 and the upper and lower two PTC heaters 18 are incorporated at predetermined positions on the inner bottom surface of the lower case 11a. After that, the substrate sub-assembly 15 is put on the upper surface of the uppermost flat heat exchange tube 17a, and the heat exchange holding member 16 of the substrate sub-assembly 15 is tightened and fixed to the boss parts 11e of the lower case 11a using the four fixing screws 15b. In this manner, the components can be incorporated in the lower case 11a in the state where pressing force of the heat exchange holding member 16 brings: the respective flat tube parts 20 of the three flat heat exchange tubes 17a, 17b, and 17c and the PTC heaters 18; the three seal members 26 respectively disposed around the communication holes 21a of the inlet header parts 21; and the three seal members 26 respectively disposed around the communication holes 22a of the outlet header parts 22, into close contact with each other.

After that, the terminals of the power supply harness 27 and the terminals 14a of the electrode plates 14 are respectively fixed to the terminal mounts 13a and 13c of the control substrate 13 provided on the upper surface of the heat exchange holding member 16, using the screws 13b and 14b. Further, the LV harness 28, the lead wires 29a and 30a of the inlet temperature sensor 29 and the outlet temperature sensor 30, and the like are connector-connected for connection of electrical lines. Lastly, the upper case (not illustrated) is screwed to the lower case 11a so as to cover an upper portion of the resultant structure. In this manner, the heat medium heating device 10 can be assembled.

In the heat medium heating device 10, the heat medium that has flown into the inlet header parts 21 through the heat medium inlet path 11c is branched into the three flat heat exchange tubes 17a, 17b, and 17c from the respective inlet header parts 21. The branched heat mediums respectively circulate in the three flat heat exchange tubes 17a, 17b, and 17c, and are heated by the plurality of PTC heaters 18. Then, the branched heat mediums join together in the outlet header parts 22, and flow out through the heat medium outlet path 11d. In this manner, the heat medium heating device 10 can serve to heat the heat medium circulating in the heat medium circulation circuit 10A of the vehicular air-conditioning device 1.

At this time, the temperature of the heat medium to be circulated in the heat medium heating device 10 and the temperature of the heat medium that is heated by the heat medium heating device 10 to be supplied to the heat radiator 6 can be detected by the paired inlet temperature sensor 29 and outlet temperature sensor 30 disposed around the inlet header part 21 and the outlet header part 22 of the lowermost flat heat exchange tube 17c. Accordingly, the heat medium heating device 10 (for example, the amount of heat applied by the plurality of PTC heaters 18) can be controlled on the basis of the detected temperatures.

The heat medium heating device 10 and the vehicular air-conditioning device 1 of the present embodiment produce the following operations and effects.

According to the heat medium heating device 10 of the present embodiment, the flat heat exchange tubes 17a, 17b, and 17c each including the inlet header part 21 and the outlet header part 22 and the PTC heaters 18 are stacked in a plurality of layers, and the stacked structure is incorporated in the casing 11 including the heat medium inlet path 11c and the heat medium outlet path 11d communicated with the inlet header parts 21 and the outlet header parts 22. In the heat medium heating device 10 thus configured, the inlet temperature sensor 29 and the outlet temperature sensor 30 that detect the temperature of the heat medium are disposed around the inlet header part 21 and the outlet header part 22 of the lowermost one 17c of the flat heat exchange tubes 17 stacked in the plurality of layers.

In this configuration, the heat medium passes through the heat medium inlet path 11c, and is branched into the three flat heat exchange tubes 17a, 17b, and 17c from the respective inlet header parts 21. The branched heat mediums are heated by the PTC heaters 18 while circulating in the three flat heat exchange tubes 17a, 17b, and 17c stacked in the plurality of layers, join together in the outlet header parts 22, and then flow out through the heat medium outlet path 11d. The inlet temperature and the outlet temperature of such a heat medium can be detected at the positions of the inlet header part 21 and the outlet header part 22 of the lowermost flat heat exchange tube 17c, at which the most representative values of the inlet temperature and the outlet temperature can be obtained.

That is, because the inlet temperature of the heat medium is detected in the inlet header part 21 of the lowermost flat heat exchange tube 17c, the inlet temperature can be detected in its lowest state before heating. Because the outlet temperature of the heat medium is detected in the outlet header part 22 of the lowermost flat heat exchange tube 17c, the outlet temperature can be detected in its highest state after heating. Accordingly, the temperature of the heat medium flowing into/out of the heat medium heating device 10 can be accurately and correctly detected, and the controllability of the heat medium heating device 10 can be enhanced by controlling the heat medium heating device 10 and the like on the basis of the temperature thus detected.

Further, in the present embodiment, the inlet temperature sensor 29 and the outlet temperature sensor 30 are provided next to each other in the space part 31 between the inlet header part 21 and the outlet header part 22 of the flat heat exchange tube 17c, at one end of the flat heat exchange tube 17c at which the inlet header part 21 and the outlet header part 22 are provided next to each other. Hence, the two inlet temperature sensor 29 and outlet temperature sensor 30 can be adjacently placed between the inlet header part 21 and the outlet header part 22. Accordingly, the inlet temperature sensor 29 and the outlet temperature sensor 30 can be placed more easily, and the lead wires 29a and 30a thereof can be connected more easily, so that assembling properties of the two temperature sensors 29 and 30 can be improved.

Further, the heat conduction insulating slit 32 is provided between the placement part 31a for the inlet temperature sensor 29 and the placement part 31b for the outlet temperature sensor 30 in the space part 31. Hence, heat conduction between the placement part 31a for the inlet temperature sensor 29 and the placement part 31b for the outlet temperature sensor 30 can be insulated by the slit 32. Accordingly, even if the two temperature sensors 29 and 30 are adjacently provided next to each other, temperature interference therebetween can be prevented, and the temperature of the heat medium can be accurately and correctly detected by each of the temperature sensors 29 and 30.

Moreover, according to the vehicular air-conditioning device 1 of the present embodiment, the heat medium to be circulated in the heat radiator 6 disposed in the airflow path 2 can be heated for circulation by the heat medium heating device 10 having improved controllability. Hence, the temperature controllability of the vehicular air-conditioning device 1, particularly, the temperature controllability thereof during air heating can be improved, thus achieving comfortable air conditioning.

Note that the present invention is not limited to the invention according to the above-mentioned embodiment, and can be modified as appropriate within the range not departing from the scope of the present invention. For example, in the above-mentioned embodiment, the flat heat exchange tubes 17 are stacked in three layers, and the PTC heater 18 is incorporated into each gap between the adjacent flat heat exchange tubes 17. The present invention is not limited thereto, and the stacking number of the flat heat exchange tubes 17 and the PTC heaters 18 may be increased or decreased, as a matter of course. Further, the example in which the casing 11 is a resin molded article is described above. The present invention is not limited thereto, and the casing 11 may be made of metal such as an aluminum alloy, as a matter of course.

### REFERENCE SIGNS LIST

1 vehicular air-conditioning device
6 heat radiator
10 heat medium heating device
10A heat medium circulation circuit
11 casing
11c heat medium inlet path
11d heat medium outlet path
17, 17a, 17b, 17c flat heat exchange tube
(17c lowermost flat heat exchange tube)
18 PTC heater
21 inlet header part
22 outlet header part
23 U-turn part
29 inlet temperature sensor
30 outlet temperature sensor
31 space part
31a inlet-side sensor placement part
31b outlet-side sensor placement part
32 slit

1. A heat medium heating device comprising:
a plurality of flat heat exchange tubes each including:
an inlet header part and an outlet header part that are provided next to each other at one end of the flat heat exchange tube; and
a U-turn part provided at another end thereof,
the inlet header part causing a heat medium to flow into the flat heat exchange tube, the U-turn part causing the heat medium to make a U-turn, and the outlet header part causing the heat medium to flow out of the flat heat exchange tube;
PTC heaters that are respectively incorporated to between the plurality of stacked flat heat exchange tubes; and
a casing having:
a bottom surface on which a heat medium inlet path and a heat medium outlet path are provided, the heat medium inlet path and the heat medium outlet path being respectively communicated with the inlet header parts and the outlet header parts of the flat heat exchange tubes; and
an inner bottom surface on which the flat heat exchange tubes and the PTC heaters are stacked and incorporated in a plurality of layers, wherein
an inlet temperature sensor and an outlet temperature sensor that detect a temperature of the heat medium are provided around the inlet header part and the outlet header part of the lowermost one of the flat heat exchange tubes stacked in the plurality of layers.

2. The heat medium heating device according to claim 1, wherein
the inlet temperature sensor and the outlet temperature sensor are provided next to each other in a space part between the inlet header part and the outlet header part, at the one end of the flat heat exchange tube at which the inlet header part and the outlet header part are provided next to each other.

3. The heat medium heating device according to claim 2, wherein
the space part is provided with a heat conduction insulating slit between a placement part for the inlet temperature sensor and a placement part for the outlet temperature sensor.

4. A vehicular air-conditioning device comprising:
a heat radiator disposed in an airflow path; and
a heat medium heating device that heats a heat medium, the heated heat medium being circulatable in the heat radiator, wherein
the heat medium heating device is the heat medium heating device according to claim 1.

5. A vehicular air-conditioning device comprising:
a heat radiator disposed in an airflow path; and
a heat medium heating device that heats a heat medium, the heated heat medium being circulatable in the heat radiator, wherein
the heat medium heating device is the heat medium heating device according to claim 2.

6. A vehicular air-conditioning device comprising:
a heat radiator disposed in an airflow path; and
a heat medium heating device that heats a heat medium, the heated heat medium being circulatable in the heat radiator, wherein
the heat medium heating device is the heat medium heating device according to claim 3.
